(19) United States
(12) Patent Application Publication
(10) Pub. No.: US 2006/0170530 A1
(43) Pub. Date: Aug. 3, 2006

(54) Fingerprint-based authentication using radio frequency identification

(75) Inventors: Kingsley Chukwudum Nwosu, Union, NJ (US); Daniel Chukwuemeka Nwosu, Newark, NJ (US); Zeribe Pius Ezeanuna, Union, NJ (US); William Agbemabiese, Union, NJ (US)

Correspondence Address: Ashok Tankha;Lipton Weinberger & Husick, 36 Greenleigh Drive, Sewell, NJ, 08080, US

(73) Assignee: Enenia Biometrics, Inc., Union, NJ (US)

(21) Appl. No.: 11/049,328

(22) Filed: Feb. 2, 2005

(51) Int. Cl. G05B 19/00

(52) U.S. Cl. 340/5.53; 340/5.61

(57) ABSTRACT

A method, apparatus and system that allows an individual to authenticate his identity by storing his or her biometric profile and other information in a smart device. The smart device is always under the control of the owner during and after enrollment. The smart device holder's identity is authenticated by matching the stored fingerprint template against the live fingerprint of the smart device holder scanned on the smart device. When an enrolled smart device is within the proximity of a system radio frequency identification reader, the associated application via the radio frequency identification reader interacts with the smart device to authenticate the identity of the person holding the device. The smart device can also be attached to a personal computer, without a radio frequency identification reader via a wired interface. The application performs the applicable transaction only when the identity of the smart device holder is successfully authenticated.

### BACKGROUND OF THE INVENTION

This invention relates to a method, apparatus and system for enabling individuals to control the access and storage of their biometric attributes that are required to authenticate their identity, before such individuals are allowed to execute a financial or other transaction. In particular, it relates to all forms of electronic transactions and activities by commercial or non-commercial institutions and entities whereby an individual's identity is required to be verified before that individual can execute a financial or other transaction.

Many of the available biometric-based authentication methods require the storage of an individual's biometric information in a smart card or a back-end host server. Storage of the biometric information of an individual, for example the individual's fingerprint, iris, facial contour, etc., that involves transmittal of the biometric information over a communication media is a security concern to the individual. The individual that provides his fingerprint is concerned over the lack of control that he has over the finger templates once the templates are electronically transmitted to a third party. This worry stems from the fact that the individual's biometric characteristic, for example his fingerprints can be transferred or sold to a third party such as law enforcement agencies without the individual's authorization or notification. Also, electronic transfer and storage of an individual's biometric attributes is viewed as an invasion of privacy issue. As a result, in most countries, persons hesitate to subscribe to any service that requires providing one's fingerprint to authenticate their identity.

Also, storage of an individual's biometric attributes on a smart card involves the risk of the loss of the smart card, or compromise of the network communication between the smart card and the personal computer or back-end server. Although the smart card on which an individual's biometric attribute is stored is generally of no use to a third party that finds the smart card that is lost or stolen, the real issue is intentional use, collaboration or sharing of information contained on the smart card between the service provider and a third party.

There is an unmet market need to provide a system and method to biometrically authenticate the identity of an individual where the individual is in control of his biometric attributes and where the service provider does not have access to, or a copy of, the individual's biometric attribute.

In this application, by way of example, the biometric attribute of the individual used for authentication of the individual will be his or her fingerprints. However this invention is applicable to any other biometric attribute, for example, the individual's iris, facial contour, etc. Furthermore, the personal and account information stored in the smart device may also include other identification of the individual, for example, the photo image of the individual.

The present invention uses special hardware and accompanying software that stores an individual's fingerprint template in a smart device controlled by the individual. The smart device holder's identity is authenticated by matching the stored fingerprint template against the live fingerprint of the smart device holder scanned on the smart device which is under the control of the smart device holder. The present invention assures that an individual's fingerprint cannot be accessed by or compromised by a third party even if the smart device is lost or stolen.

### BRIEF DESCRIPTIONS OF THE DRAWINGS

FIG. 1A is a schematic block diagram that illustrates how the smart device holder authenticates that he or she is the owner of the smart device.

FIG. 1B illustrates the method for the authentication of the smart device holder by the host application.

FIG. 2A is a block diagram that shows the method for a smart device holder to enroll in the biometric authentication system and become the smart device owner.

FIGS. 2B and 2C are logic flow diagrams that show how a smart device holder enrolls in the biometric authentication system and becomes the smart device owner

FIG. 3A is a diagram that illustrates the hardware set-up required for the smart device holder to authenticate himself or herself as the smart device owner using the smart device.

FIGS. 3B and 3C show the logic flow diagram for the smart device holder to authenticate himself or herself as the smart device owner using the smart device.

FIGS. 4A and 4B are logic flow diagrams that illustrate how the host application uses the RFID reader to request authentication of the smart device holder and to retrieve the authentication result from a smart device.

FIG. 5 is the flow diagram illustrating how the host application requests for the authentication of the smart device holder and retrieves the result of the authentication.

### DETAILED DESCRIPTION OF THE INVENTION

The following definitions will be used in this specification. The smart device is the hardware device that is used to obtain and store fingerprint templates and personal/account information of the smart device owner, and for authenticating that the holder of the smart device is the owner of that smart device. The smart device holder is an individual who holds a smart device. Once the identity of the smart device holder is authenticated by a successful enrollment with the smart device, the smart device holder is thereafter referred to as the smart device owner. The software application running on a personal computer that communicates with the radio frequency identification (RFID) reader or smart device is referred to as the host application.

At any point in time, a smart device is in one of two following hardware states: enrolled or un-enrolled. Every newly manufactured or re-initialized smart device is in an un-enrolled state. After a smart device is acquired by an a smart device holder and following the enrollment of the smart device holder on the smart device as described below, the smart device is placed in an enrolled state.

The smart device 201 is an owner controlled, integrated device consisting of a biometric scanner and a radio frequency identification card with a shared flash memory area. The shared flash memory area is used to store information for the RFID reader status area 205, the RFID reader information area 206, the fingerprint templates area 207, personal information area 208 and the reserved area 209. The shared flash memory area of the smart device 201 is also used to store communication data between the biometric scanner 202 and the host application. The biometric scanner 202 component located in the smart device 201 is used to scan and obtain the smart device holder's 200 or smart device owner's biometric profile data. The RFID card 204 component holds an RFID tag and an electrically erasable programmable read only memory (EEPROM). The smart device 201 communicates with the remote RFID reader 302 that is in communication with a personal computer running the host application. The smart device 201 can also be directly connected to a personal computer 210 via a wired communication interface. The smart device 201 may be a stand-alone device, or embedded in a cellular phone or any other portable communication device.

The smart device 201 contains a small light emitting diode (LED) and a depressible biometric scanning area on the scanner 202. When the scanner area is depressed, the LED blinks a red color if the smart device 201 is in un-enrolled state, yellow if it is in an enrolled state, and orange during enrollment. After a successful enrollment, a smart device holder 200 becomes the smart device owner.

The smart device 201 is powered by an internal rechargeable or non-rechargeable battery or solar energy.

The utilization of this invention requires the implementation of following two processes: enrollment of the smart device holder 200, and authentication of the identity of the smart device holder 200.

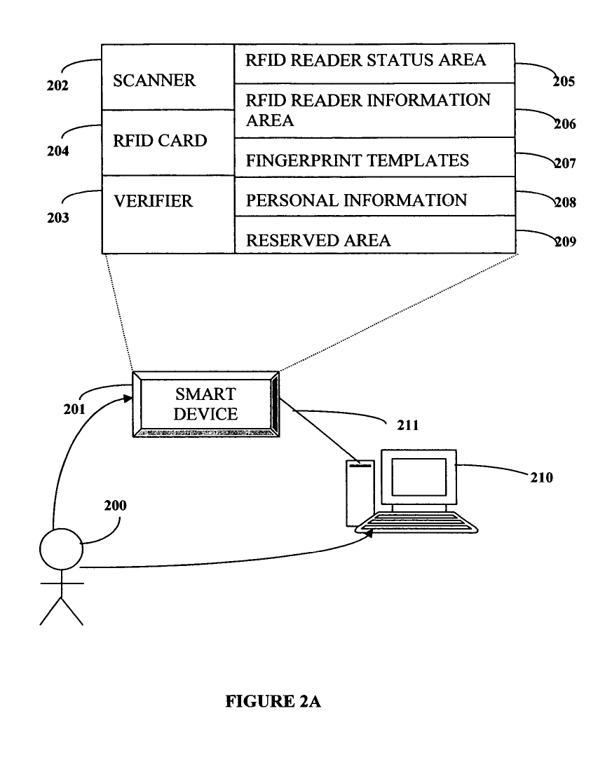

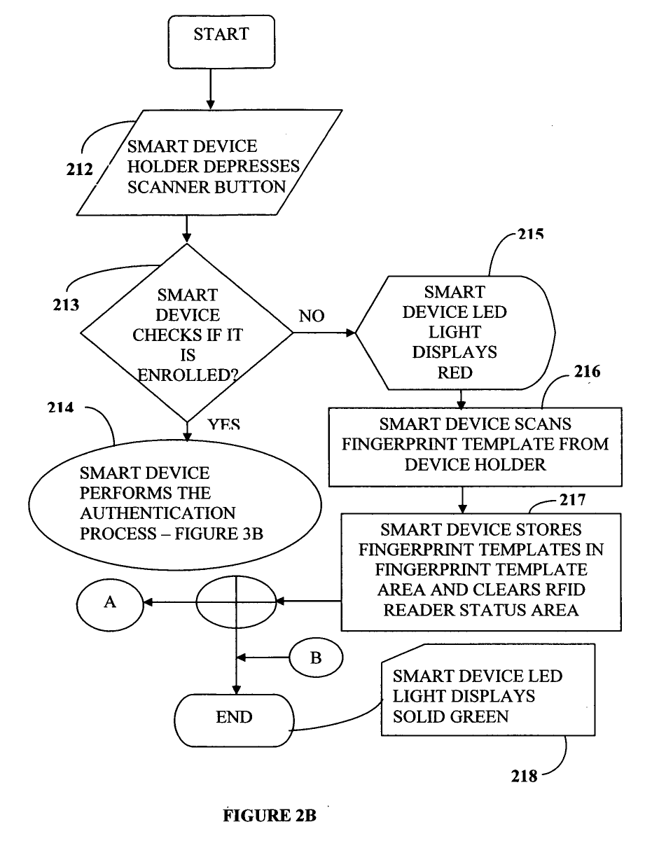

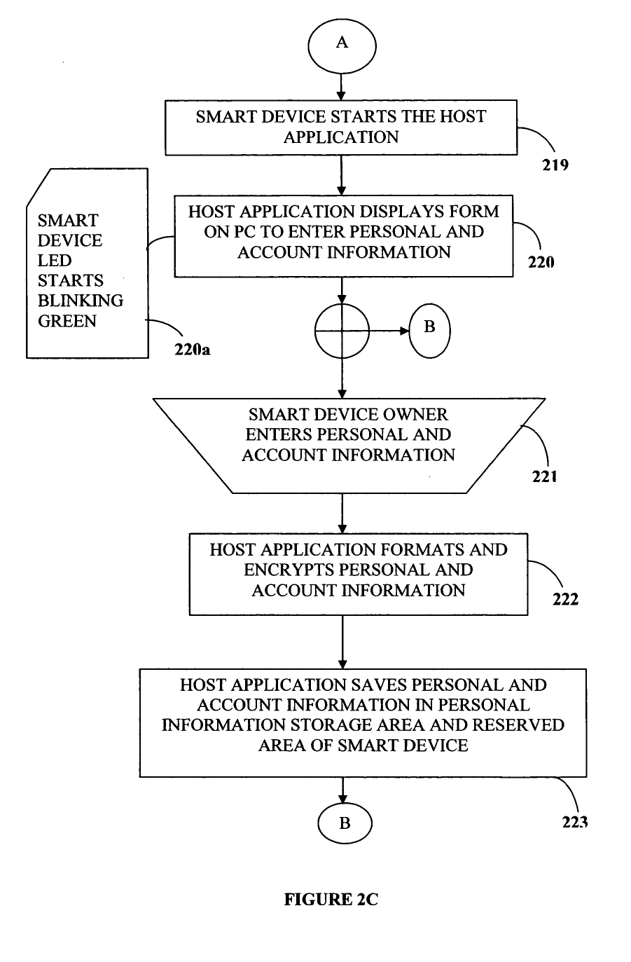

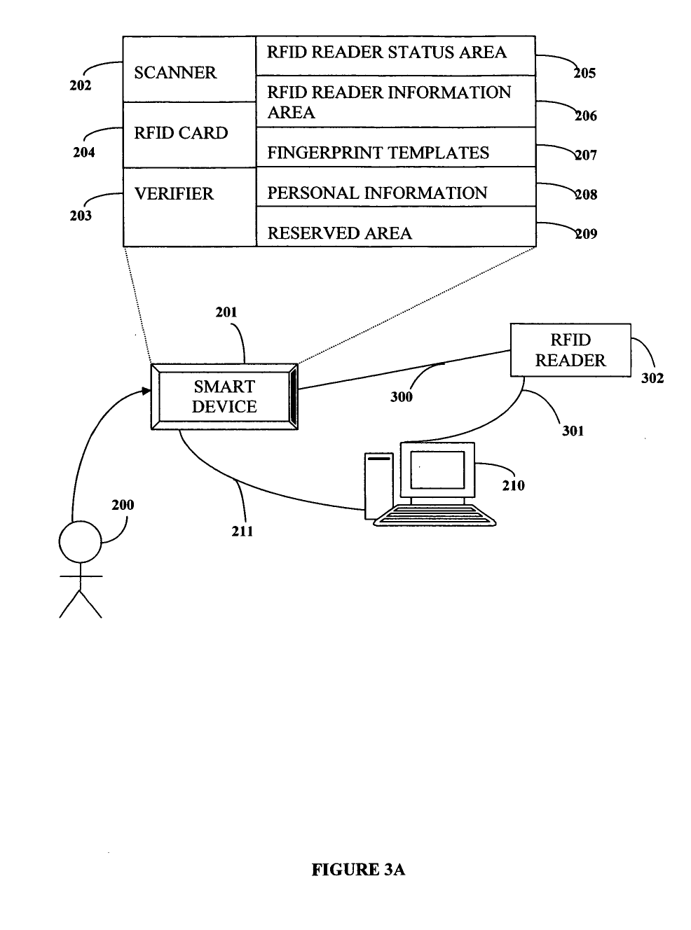

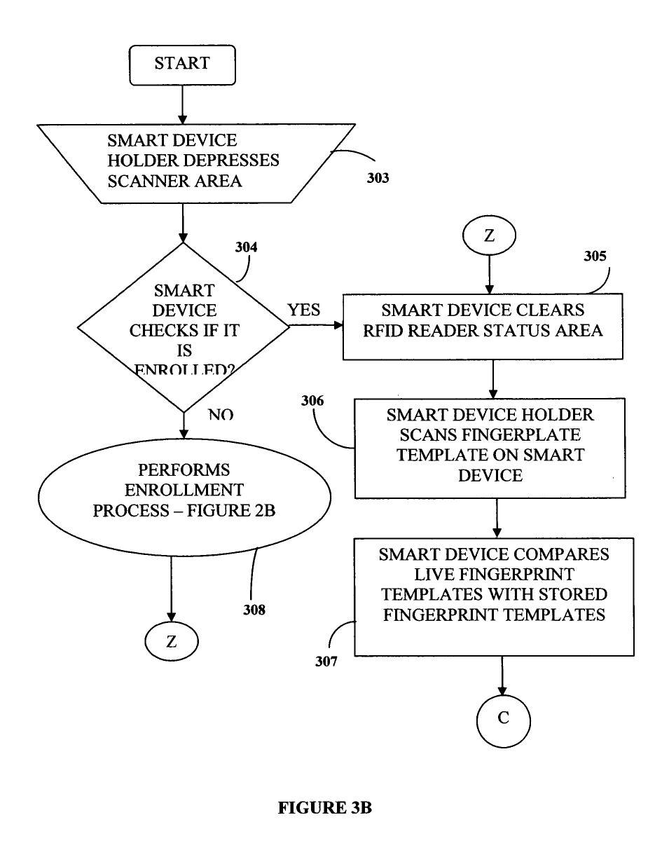

During enrollment, the host application collects, formats, encrypts and transmits the personal and account information via a wire-line communication to the smart device 201. When an RFID reader 302 is available during authentication, the host application directs the RFID reader 302 that is in wireless communication with the smart device 201, to retrieve the authentication result. When a RFID reader 302 is not available during authentication as shown in FIG. 2A, the smart device 201 is connected directly\ to the personal computer 210 and the host application communicates directly with the smart device 201 to retrieve the authentication result.

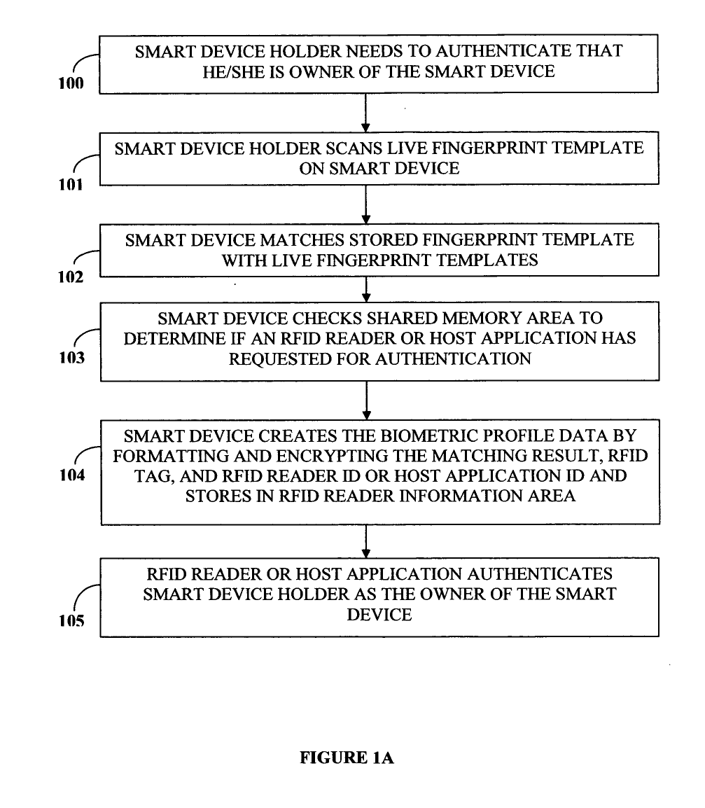

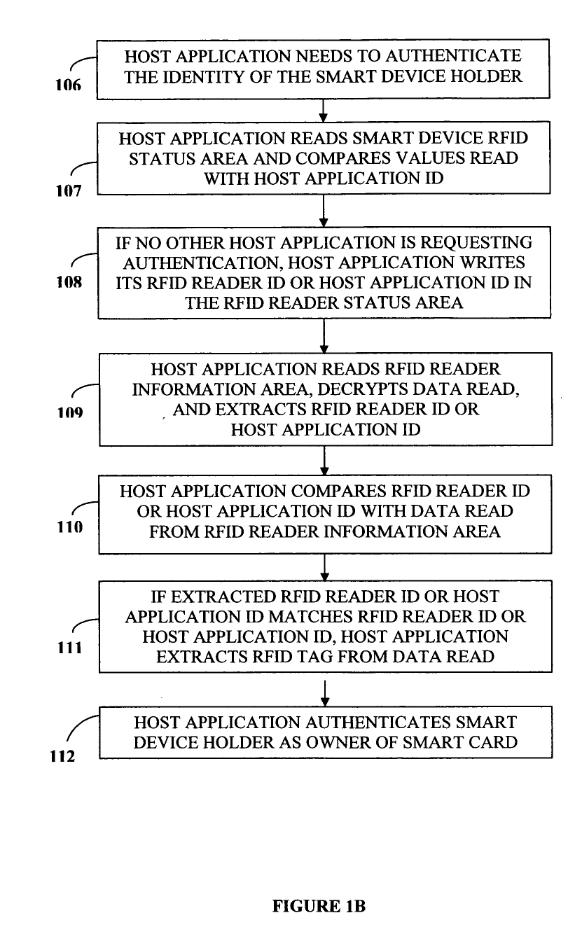

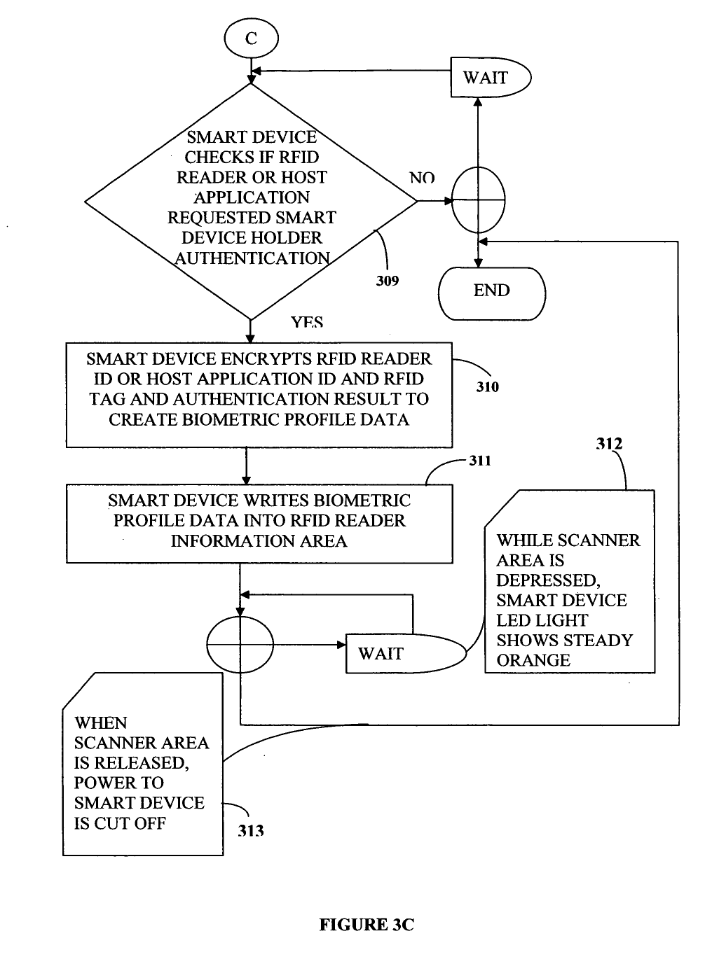

FIGS. 1A and 3A illustrates how the smart device holder 200 authenticates 100 that he or she is the owner of the smart device 201. The smart device holder 200 scans 101 his/her live fingerprint by depressing the scanner 202 area on the smart device 201. The verifier 203 on the smart device 201 matches the live fingerprint with the stored fingerprint template 102 of the smart device holder 200 and stores the result in the RFID reader information area 206. The verifier 203 module can modify the shared memory area and is capable of determining whether there is any RFID reader 302 is within range using radio frequency detection. Then the smart device 201 checks the shared memory area on the smart device 201 to determine if a RFID reader 302 or host application is requesting for an authentication 103 of the smart device holder 200. If any RFID reader or host application requests an authentication, the smart device 201 generates the biometric profile data of the device holder by formatting and encrypting the matching fingerprint result, RFID tag and RFID reader identification (ID), or host application identification (ID) and stores the data 104 in the RFID reader information area 206. An RFID reader 302 or host application reads the RFID reader information area 206, extracts the matching fingerprint result and authenticates 105 the smart device holder 200 as the owner of the smart device 201.

FIGS. 1B and 3A illustrates the method for the authentication of the smart device holder 200 by the host application. The smart device 201 communicates with the host application on the personal computer 210 via wired communication channel 211, for example, an universal serial bus (USB) or a serial connection. The host application reads the RFID reader status area 205 on the smart device 201 and compares the value read 107 with its RFID reader 302 identification (ID) or host application identification (ID). If no other RFID reader 302 or host application is requesting authentication from the smart device 201, then the host application writes 108 its RFID reader ID or host application ID in the RFID reader status area 205. At periodic intervals, the host application reads the RFID reader information area 104 of the smart device, decrypts the biometric profile data read, and extracts 109 the RFID reader ID or host application ID. The host application then compares 110 the RFID reader ID or host application ID with data read from the RFID reader information area 206. If the extracted RFID reader ID or host application ID matches the RFID reader ID or host application ID, then the host application extracts 111 the RFID tag that represents the smart device 201 and the smart device owner from the biometric profile data in the RFID reader information area 206 and authenticates 112 the smart device holder 200 as the owner of the smart device.

FIGS. 2A, 2B and 2C illustrate how a smart device holder 200 enrolls in the biometric authentication system and becomes the smart device owner after a successful enrollment. A smart device holder 200 acquires the smart device 201 from the biometric authentication system. To use the smart device, smart device holder 200 and depresses 212 the scanner 202 area with his fingers which activates the smart device 201. The smart device 201 checks 213 if it enrolled. If the smart device 214 is enrolled, it proceeds to authenticate the smart device holder 200 as shown in FIG. 3B. If the smart device 201 is in un-enrolled state, the LED on the smart device 201 will show a red color for a few seconds after which it will start blinking orange and the enrollment process is started 215. The smart device 201 scans and acquires the fingerprint templates 216 of the smart device holder 200. Once the fingerprint templates have been successfully acquired by the smart device 201, the fingerprint templates are stored 217 in the fingerprint template storage area 207, the RFID reader status area 205 is cleared, and the LED light changes to green 218. If the smart device holder 200 removes his or her finger from the scanner 202 area before the LED light changes to green, the enrollment is aborted and the smart device 201 remains in the un-enrolled state. After a successful enrollment, the smart device 201 automatically starts 219 the host application. The host application displays a form on the personal computer 210 to enter personal and account information 220 and the LED of smart device 201 starts blinking green 220a. The smart device holder 200 enters his/her personal and account information 221. The host application then formats and encrypts the personal and account information 222, and saves 223 the personal and account information in personal information storage area 208 and the reserved area 209 of the smart device 201. Also, any other application or vendor specific information is stored in reserved area 209 of the smart device 201.

FIGS. 3A, 3B and 3C show the hardware set-up and logic flow diagram for the smart device holder to authenticate himself or herself as the smart device owner using the smart device. In order to use the smart device, the smart device owner 200 must have subscribed to a biometric authentication service, or enrolled with an RFID reader device associated with a biometric authentication service. For the smart device holder 200 to authenticate himself or herself as the smart device owner, the smart device holder 200 depresses 303 the scanner area 202 with his fingers which activates the smart device 201. The smart device 201 checks if the smart device is enrolled 304 in the biometric authentication system. If the current state of the smart device 201 is un-enrolled, then it blinks red for 3 seconds and starts the enrollment process 308 of the smart device holder 200 as shown in FIG. 2B. If the current state of the smart device 201 is enrolled, then the LED blinks orange, and the authentication process continues if the scanner 202 area is still depressed by the fingers. The smart device 201 clears 305 the RFID reader status area 205. The smart device holder 200 scans 306 his or her fingerprints on the scanner 202 area; the acquired fingerprint templates are thereafter stored temporarily in the designated fingerprint template storage area 207 of the smart device 201. The smart device 201 then compares 307 the live fingerprint templates of the smart device holder 200 with the stored fingerprint templates of the smart card owner. If the smart device holder 200 releases his or her finger from the scanner area 202 during the authentication process, the smart device 201 becomes inactive. The smart device 201 then reads the content of the RFID reader status area 205 to check 309 if any RFID reader 302 or host application has requested for smart device holder 200 authentication. The smart device 201 communicates with the RFID reader 302 via a wireless communication channel 300 and communicates with the host application personal computer 210 via a wired communication channel 211. If the information in the RFID reader status area 205 indicates that no RFID reader or host application needs service, then smart device 201 will periodically re-check the area as long as smart device 201 is activated. If the information in the verifier 203 indicates that an RFID reader 302 or host application has requested service, then the smart device 201 creates the biometric profile data by formatting and encrypting the RFID reader ID extracted from the RFID reader status area 205 or the host application ID 310, the RFID tag obtained from the RFID card 204, and the authentication result and stores the information 311 in the RFID reader information area 206. After updating the RFID reader information area 206, the LED color changes to solid orange 312 as long as the smart device scanner 202 area is depressed by the finger. When the scanner area is released, the power to smart device 201 is cut off 313 and the smart device is inactivated.

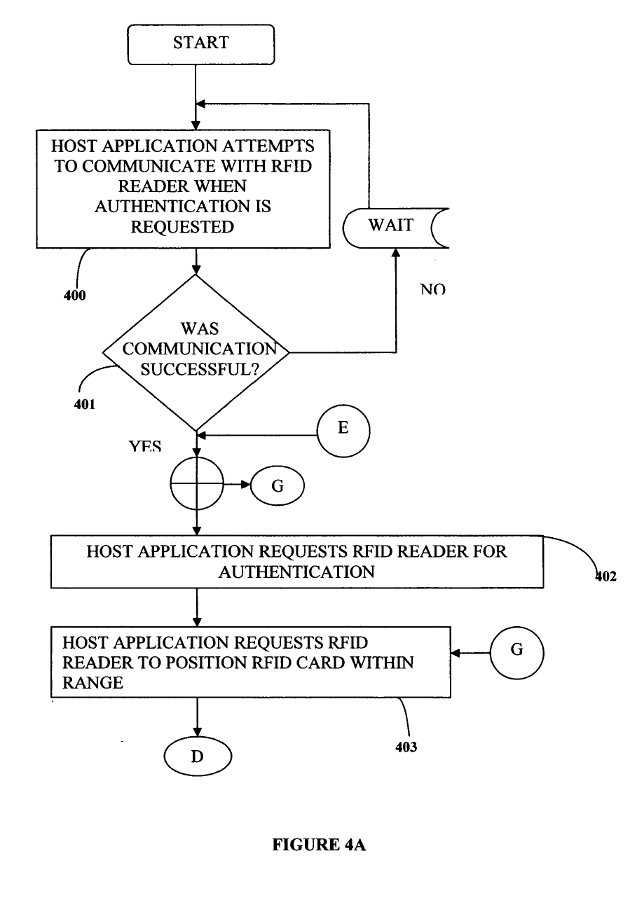

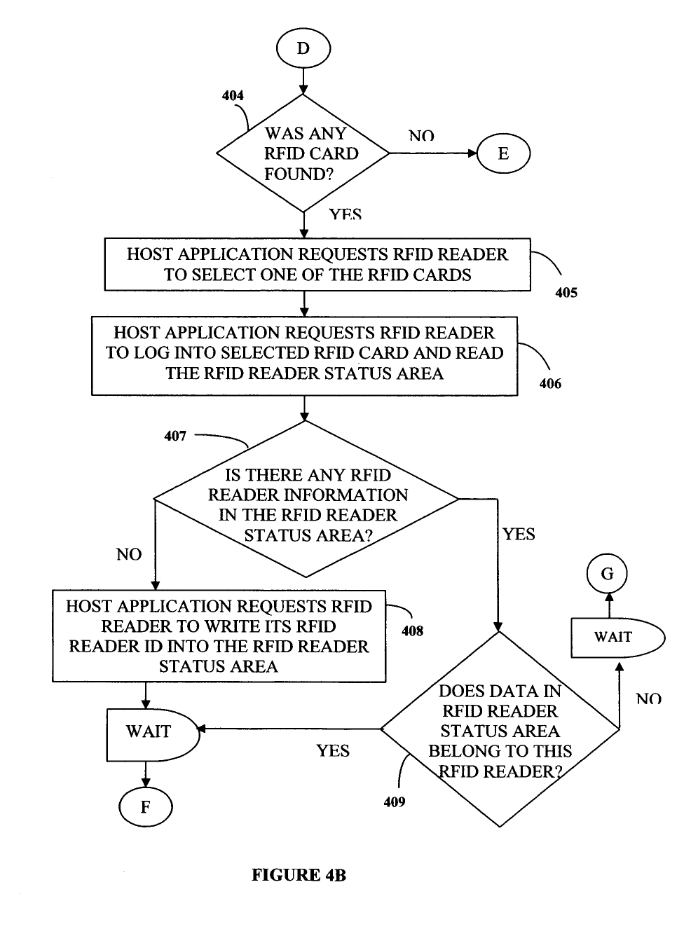

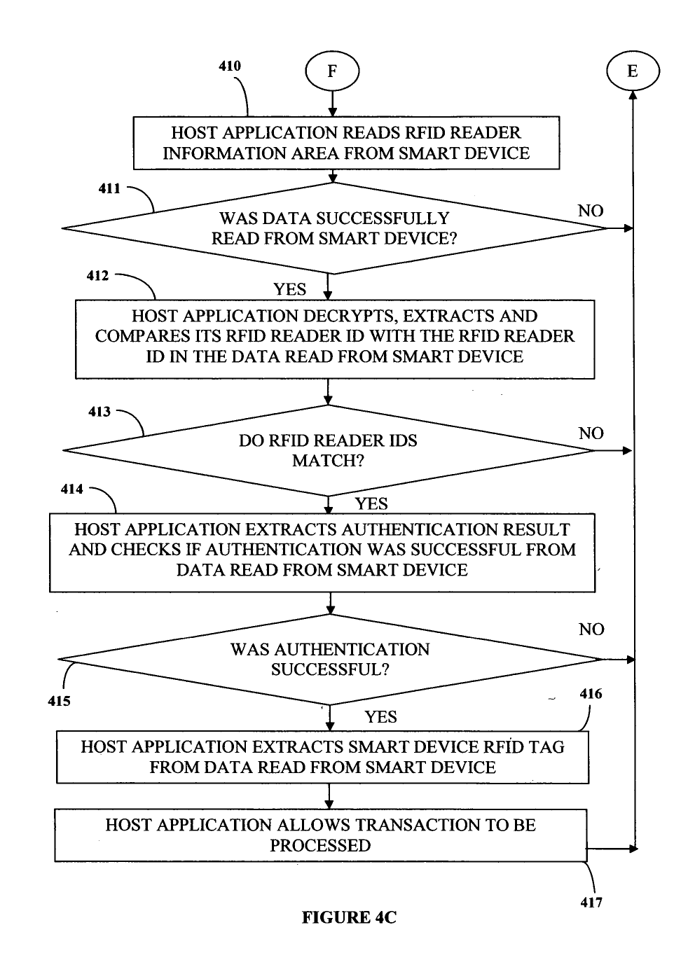

FIGS. 4A, 4B and 4C illustrate how a host application uses its associated RFID reader to request for the authentication 400, 401 of a smart device holder 200 and to retrieve the authentication result from the smart device 201. When the host application requests the RFID reader 302 to obtain 402 an authentication result that is displayed on the personal computer 210, the host application requests the RFID reader 302 to scan and position 403 a RFID card 204 within range. The RFID reader 302 then lists 404 the available RFID cards 204. Using an application controlled criterion, one of the RFID cards is selected 405 by the host application. The host application then requests 406 the RFID reader 302 to log into the selected RFID card 204, read the content of the RFID reader status area 205 for the host application and check if the data in RFID reader 302 belongs 409 to this RFID reader 302. If the current value of the RFID reader status area 205 indicates 407 that a different RFID reader 302 or host application is currently using the smart device 201, then a retry is made at periodic intervals controlled by the host application. If no other RFID reader 302 is currently using the smart device 201, then the host application requests the current RFID reader to write 408 its data, for example, RFID reader ID, etc., into the RFID reader status area 205. Periodically, the host application reads 410 the contents of RFID reader information area 206 from the smart device 201. On a successful read 411 of the RFID reader information area 206, the host application decrypts, extracts and compares 412 its RFID reader IDs or host application IDs with the RFID reader ID in the data read from the smart device 201. If the RFID reader IDs or host application IDs match 413, the host application then extracts 414 the authentication result and checks if the authentication was successful 415 from the data read from the smart device 201. If the authentication indicates a match, the host application then extracts 416 the RFID tag representing the smart device 201 and the smart device owner. The host application then allows the transaction to be processed 417. If the smart device holder 200 releases his or her fingers from the scanner 202 area at any time during this process, the smart device 201 is deactivated and communication between the RFID reader 302 or host application with the smart device 201 is discontinued.

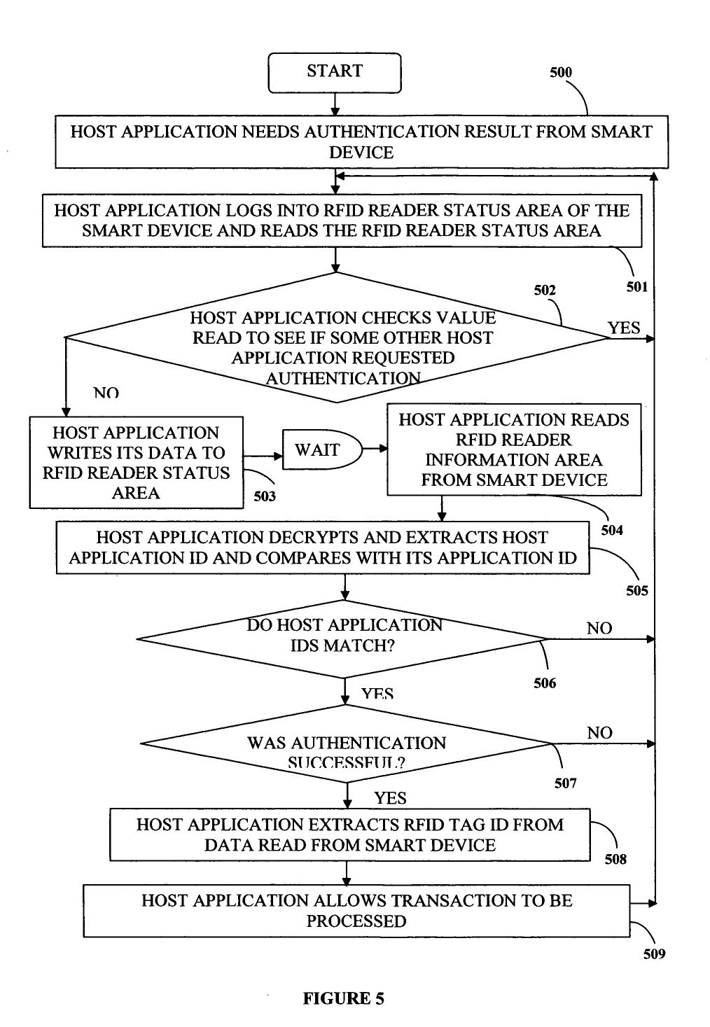

FIG. 5 illustrates how a host application that communicates with a smart device 201 via a wire-line channel 211 to a personal computer 210 requests for the authentication of the smart device holder 200 and retrieves the authentication result from the smart device. When the host application needs the authentication result 500 to allow the transaction processing to proceed, it logs into the smart device 201 associated with the communication interface 211, FIG. 3A and reads 501 the RFID reader status area 205. If the current value read indicates that a different RFID reader 302 or host application is currently using the smart device 502, then a retry is made at periodic intervals controlled by the host application. If no other RFID reader 302 is currently using the smart device 201, then the host application writes 503 its data, for example, host application ID, installation ID, etc., into the RFID reader status area 205. The host application transmits the transaction code in encrypted form to a remote back-end sever for transaction processing. Periodically, the host application reads 504 the contents of the RFID reader information area 206. The host application decrypts the data read 505 and extracts the host application ID and compares it 506 with the host application ID. The unique data generated from the tag identification of the RFID reader may be used as the record indexing key. If the host application IDs match, the host application then extracts and checks 507 the authentication result. If the check indicates a match, the host application then extracts the RFID tag representing the device and device owner 508. The host application then allows the transaction processing 509 to proceed. If the fingerprint scanner 202 area is released by the smart device holder 200 at any time during this process, the smart device 201 is deactivated and communication between the host application and the smart device 201 is discontinued.

The following example describes how a smart device holder is authenticated as the smart device owner. Mr. Doe plans to have dinner at Biometrics Restaurant and pay for the dinner using his smart device. At the checkout counter, Ms. Biomoney, cashier, pulls up Mr. Doe's bill on the personal computer and asks Mr. Doe how he would like to pay for the dinner. Mr. Doe replies that the method of payment is with a credit card and a smart device. Ms. Biomoney requests and obtains the credit card information from Mr. Doe and enters the information in a check-out application form on the personal computer. She then starts the host application, enters the credit card number, requests for authentication, and asks Mr. Doe to scan his fingerprint on the smart device. The host application communicates with the RFID reader, which communicates with the smart device to obtain the authentication result, or the host application communicates with the smart device via a wired communication interface to obtain the authentication result. If the authentication was successful, the host application retrieves the account information from the smart device and verifies that the credit card information exists in the account information. If the verification is successful, then a transaction code is generated by the host application which is then entered into the check-out application by Ms. Biomoney. She then completes the check-out application transaction.

The following example describes the method that a smart device holder uses to enroll in the biometric authentication system and become the smart device owner. Mr. John Doe purchases a smart device with a host application software, manual document, and driver software in a CD-ROM, and a USB interface and cable. He plugs in the smart device into one of the USB ports on his personal computer. He then installs the driver of the smart device as instructed in the manual, which automatically installs the host application. To start the enrollment process, Mr. Doe puts one of his fingers on the scanner liquid crystal display (LCD) area of the smart device and depresses the LCD area, which activates the smart device. The smart device determines that it is in un-enrolled state and shows a red light in its LED aperture for 3 seconds. The smart device LED then starts blinking an orange color while it scans and acquires the fingerprint templates of Mr. Doe. When the smart device has finished acquiring the fingerprint templates, it encrypts and stores them and the LED light changes to green. The smart device then starts the host application which displays a form on the personal computer for Mr. Doe to enter his personal and account information. The smart device LED light starts blinking green. Mr. Doe may cancel this information entry activity if he so desires; however, following each successful authentication, Mr. Doe will be reminded by the host application that his personal and account information is missing in the smart device. Mr. Doe fills out the display form and submits the information. The host application formats and encrypts the personal and account information and sends it to the smart device where the information is stored in the personal information storage area and reserved area. When the information is stored in the smart device or the information entry activity canceled, the LED light changes to solid green indicating the successful enrollment of Mr. Doe in the biometric authentication system.

What is claimed is:

1. A system for biometric authentication of the identity of the owner of a smart device that is in communication with a host application on a computer or a radio frequency identification reader, comprising:
a smart device, further comprising;
a radio frequency identification reader status area for storing the status of the requesting radio frequency identification reader;
a radio frequency identification reader information area for storing the encrypted result of a biometric matching process;
a biometric template area for storing both the live and stored biometric feature of the smart device owner;
a biometric scanner for scanning a live biometric feature of the owner of the smart device and storing the live biometric feature temporarily in the biometric template area;
a personal information area for storing the personal and account information of the owner of the smart device;
a verifier for matching the live biometric features against the biometric features of the owner of the smart device stored in the biometric template area;
a radio frequency identification reader in wireless communication with the smart device and by wire-line communication with a computer for reading the authentication result from the smart device;
a host application that runs on said computer wherein said radio frequency identification reader and host application reads the status from the radio frequency identification reader status area and extracts information from the radio frequency identification reader's information area and personal information area.

2. The system of claim 1, wherein the smart device contains a light emitting diode used to indicate various states of the smart device.

3. The system of claim 1, wherein the smart device communicates with the host application on the personal computer via wired communication channel.

4. The system of claim 1, wherein the smart device contains a reserved area for storing vendor or company specific information.

5. The system of claim 1, wherein the smart device is embedded in a cellular phone or any other portable communication device.

6. The system of claim 1, wherein the smart device is powered by an internal rechargeable or non-rechargeable battery or solar energy.

7. A method for authenticating a smart device holder in a biometric authentication system comprising a radio frequency identification reader, computer, host application residing in the computer and smart device, comprising the steps of:
activating the smart device by the smart card holder by depressing the scanning area on the smart device;
checking the smart device's enrollment status in the biometric authentication system by the smart device;
clearing the radio frequency identification reader status area on the smart device by the smart device if the smart device is enrolled;
scanning the live biometric feature of the smart device holder in the smart device;
comparing the live biometric feature of the smart device holder with the stored biometric feature in the smart device;
checking the radio frequency identification reader status area in the smart device to determine if any other radio frequency identification reader or any other host application has requested for the smart device holder's authentication in the radio frequency identification reader status area in the smart device;
encrypting and writing the biometric profile data containing the radio frequency identification reader identification or host application identification, radio frequency identification tag, and authentication result into the radio frequency identification reader information area of the smart device, wherein said encrypting and writing is performed by the smart device, whereby the transaction requested by the smart device owner is allowed to be processed.

8. The method of claim 7, wherein the smart device is in an enrolled state or un-enrolled state.

9. The method of claim 7, wherein the personal and account information of the smart device holder are stored in the smart device after encryption using proprietary or open encryption algorithm or method.

10. The method of claim 7, wherein the authentication is activated periodically by the host application or by an explicit request from the host application.

11. The method of claim 7, wherein the authentication is terminated by a periodic activity of the host application or by an explicit request from the host application or inactivity by the smart device.

12. The method of claim 7, wherein the host application via the radio frequency identification reader is capable of determining whether the data in the shared memory area is intended for its radio frequency identification reader.

13. The method of claim 7, wherein the host application is capable of decrypting the data retrieved from the smart device to extract the matching result, associated tag identification and biometric profile code.

14. The method of claim 7, wherein the host application generates a transaction code for payment processing.

15. The method of claim 7, wherein the host application transmits the transaction code in encrypted form to a remote back-end system for transaction processing.

16. The method of claim 7, wherein the authentication data is transmitted to the host application via a wired or wireless communication channel from the smart device.

17. The method of claim 7, wherein the unique data generated from the tag identification of the radio frequency identification reader can be used as the record indexing key.

18. The method of claim 7, wherein the verifier module can modify the shared memory areas.

19. The method of claim 7, wherein the verifier module is capable of determining whether there is any radio frequency identification reader within range using radio frequency detection.

20. The method of claim 7, wherein the smart device uses a light emitting diode to signal the states of the smart device and to indicate when fingerprint scanning begins and ends.

21. The method of claim 7, wherein the radio frequency identification reader selects one smart device from a plurality of available smart devices by default, or as specified by the host application.

22. A method for enrolling a smart device holder as the smart device owner in a biometric authentication system comprising the steps of:
depressing the smart device scanner area by the smart device holder to activate the smart device;
determining that the smart device is in an un-enrolled state by the smart device;
scanning the fingerprints templates of the smart device holder on the smart device;
storing the fingerprint templates in the fingerprint template area of the smart device by the smart device;
starting the host application by the smart device;
displaying a form on the personal computer to enter the personal and account information by the host application;
entering the personal and account information on the form by the smart device owner;
formatting and encrypting the personal and account information by the host application; and
saving the personal and account information in the personal information storage area and reserved area of the smart device by the host application.

23. The method of claim 22, wherein the smart device is attached to a personal computer via a wire-line communication channel.

24. The method of claim 22, wherein the personal computer contains a host application for communicating with the smart device.

25. The method of claim 22, wherein the smart device is an integrated device comprising a biometric scanner, an radio frequency identification card, and shared memory areas.

26. The method of claim 22, wherein depressing the smart device scanning area activates the smart device and releasing the scanning area de-activates the smart device.

27. The method of claim 22, wherein enrollment is performed only when the smart device is in an un-enrolled state.

28. The method of claim 22, wherein the personal information may include the photo image of the device owner.

29. The method of claim 22, wherein the encryption uses open or private encryption algorithm.

30. The method of claim 22, wherein the reserved area is used for application or vendor specific information.
